(19) United States
(12) Patent Application Publication
(10) Pub. No.: US 2016/0127751 A1
(43) Pub. Date: May 5, 2016

(54) METHOD AND APPARATUS FOR PROVIDING A BROADCASTING SERVICE

(71) Applicant: Samsung Electronics Co., Ltd., Suwon-si (KR)

(72) Inventor: Yoon-Hee CHOI, Suwon-si (KR)

(21) Appl. No.: 14/933,656

(22) Filed: Nov. 5, 2015

(30) Foreign Application Priority Data
Nov. 5, 2014 (KR) 10-2014-0152985

(51) Int. Cl. H04N 21/25; H04N 21/45; H04N 21/466; H04N 21/4788; H04N 21/258

(52) U.S. Cl. CPC H04N 21/252; H04N 21/4788; H04N 21/25891; H04N 21/4667; H04N 21/4532

(57) ABSTRACT

A method and an apparatus for providing a broadcasting service are provided. The apparatus of the server includes a communication interface, and a processor configured to receive a social media data from social media server through the communication interface, obtain broadcasting information from the social media data, receive broadcasting viewing log information from at least one electronic device through the communication interface, and control the communication interface to send preference information of at least one broadcasting program determined based on the broadcasting information and the broadcasting viewing log information, to the at least one electronic device.

### CROSS-REFERENCE TO RELATED APPLICATION(S)

This application claims the benefit under 35 U.S.C. §119(a) of a Korean patent application filed on Nov. 5, 2014 in the Korean Intellectual Property Office and assigned Serial number 10-2014-0152985, the entire disclosure of which is hereby incorporated by reference.

### TECHNICAL FIELD

The present disclosure relates to providing a broadcast service. More particularly, the present disclosure relates to measuring broadcasting program preference.

### BACKGROUND

In the past, a television was the only device for watching a broadcasting program, and viewers watched a broadcasting program on the television in real time. Accordingly, a television rating of the broadcasting program is proportional to broadcasting program preference. However, a broadcasting program can be viewed now through not only the television but also a smart phone, and many users download or replay the broadcasting program without having to view the broadcasting program in real time. Home video recording of television programming when broadcast for later viewing is now common, and television programming can also be downloaded on demand for viewing on network-connected devices such as televisions, smart phones, computers, etc. As a result, the broadcasting program rating may not be proportional to the true preference of the corresponding broadcasting program. That is, measurement of a viewing audience at a time of broadcasting according to the related art may not accurately measure or indicate the popularity of a program.

Since the broadcasting program rating is not always proportional to the broadcasting program preference, it not easy for the viewers to identify a popular broadcasting program merely based on television rating information collected by a broadcasting station. In addition, it is not easy to identify a high-rating broadcasting program among current broadcasting programs aired in real time.

In this regard, what is needed is a method for the viewers to easily identify a popular broadcasting program and/or a high-rating broadcasting program.

The above information is presented as background information only to assist with an understanding of the present disclosure. No determination has been made, and no assertion is made, as to whether any of the above may be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure to provide a method and an apparatus for providing a broadcasting service in a server.

Another aspect of the present disclosure is to provide a method and an apparatus for measuring broadcasting program preference based on broadcasting program rating information and social media information in a server.

Another aspect of the present disclosure is to provide a method and an apparatus for providing broadcasting program preference information to a broadcasting output device in a server.

Another aspect of the present disclosure is to provide a method and an apparatus for outputting broadcasting program preference information in a broadcasting output device.

Another aspect of the present disclosure is to provide a method and an apparatus for determining a real-time issue scene of a current broadcasting program in a server.

Another aspect of the present disclosure is to provide a method and an apparatus for outputting real-time issue scene information in a broadcasting output device.

In accordance with an aspect of the present disclosure, an apparatus of a server is provided. The apparatus includes a communication interface and a processor configured to receive social media data from social media server through the communication interface, obtain broadcasting information from the social media data, receive broadcasting viewing log information from the at least one electronic device through the communication interface, and control the communication interface to send preference information of at least one broadcasting program determined based on the broadcasting information and the broadcasting viewing log information, to the at least one electronic device.

In accordance with another aspect of the present disclosure, an electronic device is provided. The electronic device includes a display, a communication interface, and a processor configured to receive issue scene information of a broadcasting program from at least one server and control the display to output the received broadcasting program issue scene information through the display.

In accordance with another aspect of the present disclosure, an operating method of a server is provided. The operating method includes receiving social media data from social media server, obtaining broadcasting information from social media data, receiving broadcasting viewing log information from at least one electronic device, and sending preference information of at least one broadcasting program determined based on the broadcasting information and the broadcasting viewing log information, to the at least one electronic device.

In accordance with another aspect of the present disclosure, an operating method of an electronic device is provided. The operating method includes receiving issue scene information of a broadcasting program from a server and displaying the received broadcasting program issue scene information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system for providing a broadcasting service according to an embodiment of the present disclosure;

FIG. 2 illustrates a server according to an embodiment of the present disclosure;

FIG. 3 illustrates a network including a broadcasting output device according to an embodiment of the present disclosure;

FIG. 4A illustrates a method for determining broadcasting program preference in a server according to an embodiment of the present disclosure;

FIG. 4B illustrates a method for determining a real-time issue scene and a reason of the issue scene in a server according to an embodiment of the present disclosure;

FIG. 5A illustrates a method for outputting broadcasting program preference in a broadcasting output device according to an embodiment of the present disclosure;

FIG. 5B illustrates a method for determining a real-time issue scene and a reason of the issue scene in a broadcasting output device according to an embodiment of the present disclosure;

FIG. 6 illustrates broadcasting program analysis in a server according to an embodiment of the present disclosure;

FIG. 7 illustrates detailed broadcasting program analysis in a server according to an embodiment of the present disclosure;

FIG. 8 illustrates broadcasting program preference information output on a television according to an embodiment of the present disclosure;

FIG. 9 illustrates detailed broadcasting program preference information output on a television according to an embodiment of the present disclosure;

FIG. 10 illustrates broadcasting program preference information output on a smart phone according to an embodiment of the present disclosure;

FIG. 11 illustrates real-time issue information output from a broadcasting output device according to an embodiment of the present disclosure; and

FIG. 12 illustrates an electronic device for supporting a broadcasting output function according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Expressions such as “include” or “may include” that may be used in the present disclosure indicate existence of a disclosed relevant function, operation, or element, etc., and do not limit additional one or more functions, operations, or elements, etc. Also, it should be understood that terms such as “include” or “have” in the present disclosure are intended for designating the existence of a characteristic, a number, an operation, an element, a part, or a combination thereof described in this disclosure and do not exclude in advance the existence or additional possibility of one or more other characteristics, numbers, operations, elements, parts, or a combination thereof.

An expression such as “or”, etc. in the present disclosure includes a certain and all combinations of words listed together. For example, “A or B” may include A or may include B, or may include both A and B.

In the present disclosure, expressions such as “1^{st},” “2^{nd},” “first,” or “second,” etc. may modify various elements of the present disclosure but do not limit relevant elements. For example, these expressions do not limit sequence and/or importance, etc. of relevant elements. The expressions may be used for distinguishing one element from another element. For example, both a first user apparatus and a second user apparatus are all user apparatuses, and represent different user apparatuses. For example, a first element may be referred to as a second element, and similarly, the second element may be referred to as the first element.

When it is mentioned that a certain element is “connected to” or “accesses” another element, it should be understood that the element may be directly connected to another element or may directly access another element, but still another element may exist in the middle. In contrast, when it is mentioned that a certain element is “directly connected to” or “directly accesses” another element, it should be understood that still another element does not exist in the middle.

Terminology used in the present disclosure is used for explaining a specific embodiment and is not intended for limiting the present disclosure. Unless clearly expressed otherwise, expression of the singular includes expression of the plural.

Unless defined differently, all terminologies used herein including technological or scientific terminologies have the same meaning as that generally understood by a person of ordinary skill in the art to which the present disclosure belongs. It should be understood that generally used terminologies defined by a dictionary have meanings consistent with meanings of a related technology, and unless clearly defined in the present disclosure, they are not understood as an ideal or excessively formal meaning.

The term “module” as used herein may be defined as, for example, a unit including a combination of one or two or more among a hardware, a software, or a firmware. The term “module” may be interchangeably used with the phrase unit, logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include one or more of an application-specific integrated circuit (ASIC) chip, a field-programmable gate arrays (FPGAs), or a programmable-logic device which are known, or to be developed in the future, and performing certain operations.

An electronic device according to the present disclosure may be a device including a communication function. For example, an electronic device may include one or more of, but is not limited to, a smartphone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a mobile medical device, a camera, or a wearable device (e.g., a head-mounted-device (HMD) such as electronic glasses, an electronic clothing, an electronic bracelet, an electronic necklace, an electronic appcessory, an electronic tattoo, or a smartwatch).

The electronic device may be a smart home appliance having a communication function. A smart home appliance may include, but is not limited to, one or more of a television, a digital versatile disk (DVD) player, an audio, a refrigerator, an air conditioner, a cleaner, an oven, an electronic range, a washing machine, an air purifier, a set-top box, a TV box (e.g., Samsung HomeSync®, Apple TV®, or Google TV®), game consoles, an electronic dictionary, an electronic key, a camcorder, or an electronic frame.

The electronic device may include, but is not limited to, one or more of various medical devices (e.g., magnetic resonance angiography (MRA), magnetic resonance imaging (MRI), computed tomography (CT), a shooting device, an ultrasonic device, etc.), a navigation device, a global positioning system (GPS) receiver, an event data recorder (EDR), a flight data recorder (FDR), an automobile infotainment device, electronic equipment for a ship (e.g., a navigation device for a ship, a gyro compass, etc.), avionics, a security device, or a robot for an industrial use or a home use.

The electronic device may include, but is not limited to, one or more or more of furniture or a portion of a building/structure including a communication function, an electronic board, an electronic signature receiving device, a projector, or various measurement devices (e.g., waterworks, electricity, gas, or radio wave measuring device, etc.). The electronic device may be a combination of one or more of the above-described devices. Also, the electronic device is not limited to the above-described devices.

Hereinafter, an electronic device is described with reference to the accompanying drawings. A user as described herein may indicate a person who uses an electronic device or a device (e.g., an artificial intelligence electronic device) that uses the electronic device.

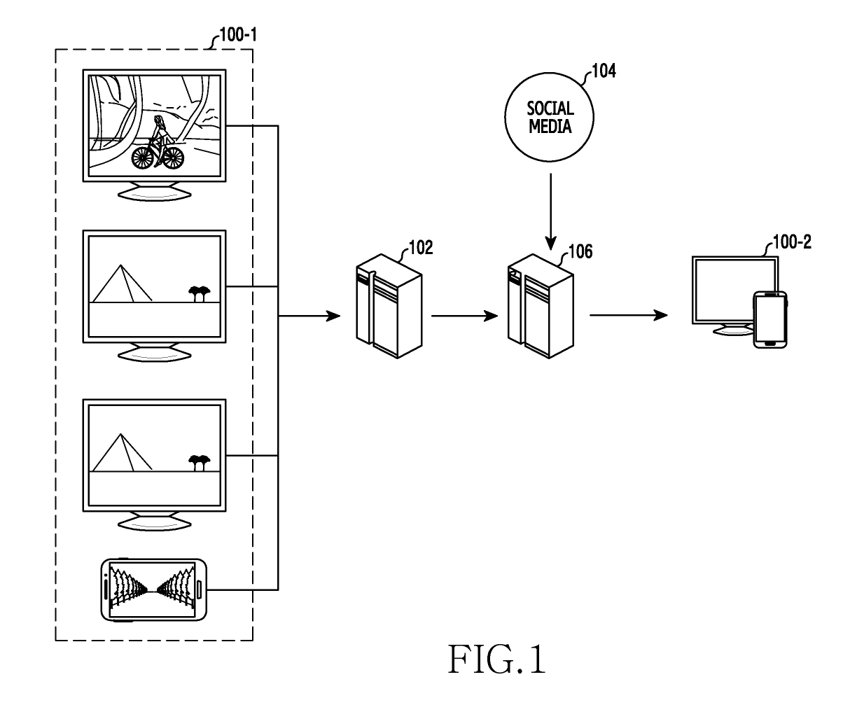

FIG. 1 depicts a system for providing a broadcasting service according to an embodiment of the present disclosure.

Referring to FIG. 1, the system for providing the broadcasting service can include a broadcasting output device 100-1 or 100-2, a server 102 for the broadcasting output device 100-1, a social media server 104, and a broadcasting service server 106.

The broadcasting output device 100-1 or 100-2 indicates an electronic device capable of outputting a broadcasting program. For example, the broadcasting output device 100-1 or 100-2, which is the electronic device for outputting a broadcasting program, can embrace a smart phone having television and digital multimedia broadcasting (DMB) functionalities and/or a portable terminal such as a tablet PC.

The server 102 for the broadcasting output device 100-1 can collect a real-time viewing log from the broadcasting output device 100. For example, the server 102 can receive viewing log information of broadcasting programs viewed by a user using an electronic device, from a television and a portable terminal. Next, the server 102 can forward the real-time viewing log information received from the broadcasting output device 100-1, to the broadcasting service server 106.

A social media indicates a platform for sharing information and opinions among users who subscribe to a social networking service (SNS) such as Twitter™ and Facebook™.

The social media server 104 can filter broadcasting program information in social media data and send the filtered broadcasting program information to the broadcasting service server 106. For example, the social media server 104 can extract text information relating to the broadcasting program from the social media data, and send the extracted broadcasting program text information to the broadcasting service server 106. More specifically, the social media server 104 can extract the broadcasting program information based on a broadcasting program title, an abbreviation for the broadcasting program title, a broadcaster, and a broadcasting station.

The broadcasting service server 106 can determine the broadcasting program preference and a real-time issue scene by analyzing the information received from the server 102 and the social media server 104, and provide the determined information to the broadcasting output device 100-2. For example, the broadcasting service server 106 can determine the preference of current broadcasting programs based on the real-time viewing log information and the broadcasting program information, determine an issue scene of the current broadcasting programs, and send the program preference information and the issue scene information to the broadcasting output device 100-2, so as to provide them to the viewers.

While the server 102, the social media server 104, and the broadcasting service server 106 are the separate entities of the broadcasting service providing system in FIG. 1, the server 102, the social media server 104, and the broadcasting service server 106 can be unified. Hereinafter, to ease the understanding, the server 102, the social media server 104, and the broadcasting service server 106 are integrated into a single server. It is noted that the single server can be divided into at least two servers which conduct different functions.

While the broadcasting output device 100-1 and the broadcasting output device 100-2 are the separate entities of the broadcasting service providing system in FIG. 1, the broadcasting output device 100-1 and 100-2 may be same.

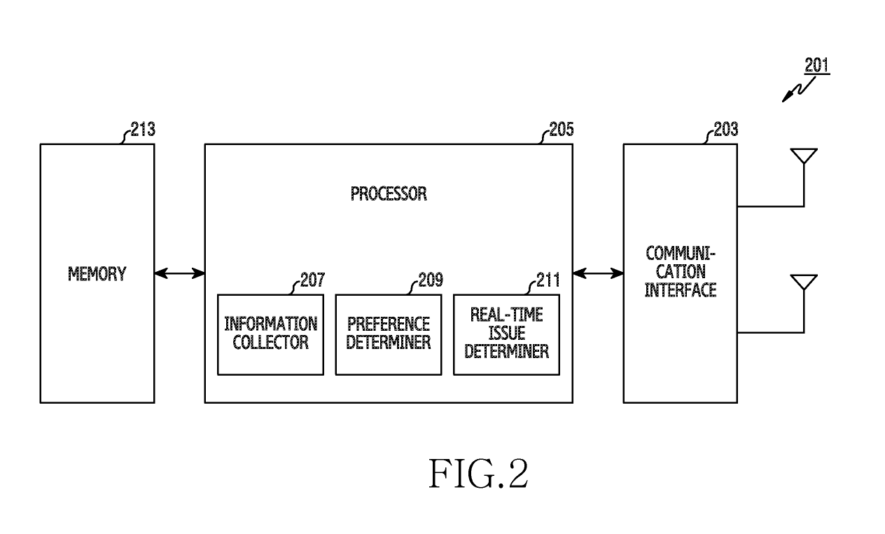

FIG. 2 is a block diagram of a server according to an embodiment of the present disclosure.

Referring to FIG. 2, the server 201 can include a communication interface 203, a processor 205, and a memory 213.

The communication interface 203 can connect communication between the server 201 and an external device (e.g., the broadcasting output device). For example, the communication interface 203 can be wirelessly connected to a network and communicate with the broadcasting output device. The wireless communication can include, at least one of, for example, WiFi, Bluetooth™ (BT), bluetooth low energy (BLE), near field communication (NFC), satellite communication (e.g., global positioning system (GPS)), and cellular communication (e.g., long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM)). The communication interface 203 can obtain social media data including user information. The user information can include a user's personal information (e.g., gender, age, residence, job, etc.) and user posting information. For example, the communication interface 203 can monitor the social media data and collect the user's posting (e.g., text, photo, video, etc.) information. The communication interface 203 can receive real-time log information from the broadcasting output device. The communication interface 203 can receive viewing log information indicating a broadcasting program output from the corresponding broadcasting output device, from at least one broadcasting output device. For example, the communication interface 203 can receive viewing log information indicating a first broadcasting program being output from a first broadcasting output device, and viewing log information indicating the first broadcasting program being output from a second broadcasting output device. Further, the communication interface 203 can receive audio data, video data, and text information from a broadcasting capture server. For example, the communication interface 203 can receive audio information, video information, and text information (e.g., caption information) of a current broadcasting program from the broadcasting capture server. For example, the communication interface 203 can receive audio information, video information, and text information (e.g., caption information) of broadcasting programs to be aired during a certain time period, from the broadcasting capture server. Further, the communication interface 203 can send at least one of the broadcasting program preference information and the real-time issue scene information to the broadcasting output device under control of the processor 205.

The processor 205 can process and control the operations of the server 201. In particular, the processor 205 can include an information collector 207, a preference determiner 209, and a real-time issue determiner 211.

The information collector 207 can acquire a user's personal information and emotion information based on the user information obtained by monitoring the social media data. The information collector 207 can acquire the user's gender, age, residence, and job information based on the user's personal information of the user information obtained by monitoring the social media data. For example, based on the user's personal information of the user information obtained by monitoring the social media data, the information collector 207 may confirm that a social media user is a female in her twenties and a company employee living in Seoul. Based on postings of the identified user, the information collector 207 can estimate a broadcasting program viewed by the corresponding user. For example, when a first user writes postings relating to a first broadcasting program most, the information collector 207 may estimate that the first user views the first broadcasting program.

The information collector 207 can identify the broadcasting program viewed by the user by filtering the broadcasting program information from the user's posting in the user information obtained by monitoring the social media data, and estimate the user's gender and age based on characteristics and type of the broadcasting program viewed by the user. For example, when filtering (or monitoring) broadcasting program information during a certain time period in the postings of the first social media user and confirming that the user writes postings on a children's broadcasting program the most, the information collector 207 may estimate that the first user is a child or a family member of the child. When filtering (or monitoring) broadcasting program information during a certain time period in the postings of the first social media user and confirming that the user writes postings on a beauty broadcasting program the most, the information collector 207 may estimate that the first user is a woman or a beauty stylist. As such, the information collector 207 can estimate the personal information such as gender, age, and/or profession of the social media user based on the user information of the social media data received for a certain time.

By filtering the broadcasting program information from the user's posting in the user information obtained by monitoring the social media data, the information collector 207 can determine whether the user feels positive or negative about the corresponding broadcasting program. For example, when filtering broadcasting program information in the postings of the first social media user and confirming that the user writes a negative posting of “not interesting” on a first broadcasting program, the information collector 207 may determine that the first user is negative about the first broadcasting program. For example, when filtering broadcasting program information in the postings of the first social media user and confirming that the user writes a positive posting of “interesting” on a second broadcasting program, the information collector 207 may determine that the first user is positive about the second broadcasting program.

Next, the information collector 207 can collect the estimated and determined information of the users, and determine a viewer age distribution map, a viewer gender ratio, and viewer emotion information (or viewer opinion information) per broadcasting program.

The preference determiner 209 can determine the broadcasting program preference based on the user information collected by monitoring the social media data and the viewing log information received from the broadcasting output device. The preference determiner 209 can filter the broadcasting program information from the user information collected by monitoring the social media data, and determine the amount of “buzz” per broadcasting program based on the filtered information. The buzz amount per broadcasting program can indicate how often information relating to the corresponding broadcasting program is mentioned in social media postings. The preference determiner 209 can determine the broadcasting program rating based on the viewing log information received from the broadcasting output device. Next, the preference determiner 209 can determine the broadcasting program preference based on the broadcasting program buzz and the broadcasting program rating. In so doing, the preference determiner 209 can determine the broadcasting program preference by applying different weights of the buzz and the rating according to a main viewing age group per broadcasting program. For example, when main viewers of the first broadcasting program are in a ten-to-twenty age group including many social media users, the preference determiner 209 may determine the preference of the first broadcasting program by applying a higher buzz weight of the first broadcasting program than the rating weight of the first broadcasting program. For example, when main viewers of the second broadcasting program are in a fifty-to-sixty age group including fewer social media users, the preference determiner 209 may determine the preference of the second broadcasting program by applying a higher rating weight of the second broadcasting program than the buzz weight of the second broadcasting program.

Next, the preference determiner 209 can send the determined broadcasting program preference information to the broadcasting output device. For example, when receiving a broadcasting program preference information request from the broadcasting output device, the preference determiner 209 can send the corresponding information to the broadcasting output device. For example, the preference determiner 209 can send the broadcasting program preference information to the broadcasting output device at preset time intervals. In so doing, the preference determiner 209 can also send the broadcasting program viewer age distribution map, the viewer gender ratio, and the viewer emotion information to the broadcasting output device.

The real-time issue determiner 211 can determine a real-time issue scene and its reason based on the user information obtained by monitoring the social media data, the viewing log information received from the broadcasting output device, and the audio/video/text information received from the broadcasting capture server. The real-time issue determiner 211 can filter the broadcasting program information from the user information obtained by monitoring the social media data, and determine a broadcasting program of increasing buzz based on the filtered information. For example, the real-time issue determiner 211 may identify a broadcasting program of which an instantaneous buzz increase exceeds a preset threshold. The real-time issue determiner 211 can identify a broadcasting program of increasing rating based on the viewing log received from the broadcasting output device. For example, the real-time issue determiner 211 may identify a broadcasting program of which an instantaneous rating increase exceeds a preset threshold. The real-time issue determiner 211 may determine candidate issue scenes based on the audio/video/text information received from the broadcasting capture server. For example, the real-time issue determiner 211 may analyze the audio information received from the broadcasting capture server and determine a scene of an audio volume exceeding a preset threshold, as the candidate issue scene. For example, when analyzing the video information received from the broadcasting capture server and confirming a particular scene replayed more than twice, the real-time issue determiner 211 may determine the corresponding scene as the candidate issue scene. For example, when analyzing the text information received from the broadcasting capture server and confirming a particular text being output in a larger size than a preset size or being highlighted, the real-time issue determiner 211 may determine a scene of the corresponding text as the candidate issue scene. When closed captioning of a broadcasting stream includes a particular word combination, the real-time issue determiner 211 may determine a corresponding scene as the issue scene. For example, when the closed captioning indicates a word combination relating to “goal” in a soccer game and a word combination relating to “home run” or “It's gone” in a baseball game, the real-time issue determiner 211 may determine a corresponding scene as the issue scene. Further, the real-time issue determiner 211 registers a particular word to the server 102 or the broadcasting service server 106 under user control. When the registered word is included in the closed captioning, the real-time issue determiner 211 may determine the issue scene personalized for the user of the electronic device. For example, when a word “Samsung” is registered to the broadcasting service server 106 under control of a first user, the real-time issue determiner 211 may provide the corresponding scene, as the issue scene, to the user every time the closed captioning includes the word “Samsung.”

In so doing, the candidate issue scene may be determined through machine learning. For example, audio/video/text features of the issue scenes are repeatedly machine-learned. When receiving a scene indicating a similar feature to the learned audio/video/text features from the broadcasting capture server, the real-time issue determiner 211 may determine the corresponding scene as the issue scene.

Next, the real-time issue determiner 211 may determine a real-time issue scene and its reason based on the broadcasting program of the abruptly increasing buzz, the broadcasting program of the abruptly increasing rating, and the determined candidate issue scenes. The reason of the real-time issue scene explains why the corresponding scene is the issue. The reason of the real-time issue scene may be determined based on the filtered information of the broadcasting program information obtained by monitoring the social media data and the text information of the broadcasting program. For example, the real-time issue determiner 211 filters the broadcasting program information obtained by monitoring the social media data at the time of the real-time issue scene determination or the broadcasting. When postings relating to “Park Ji-sung” are uploaded most and the text information of the broadcasting program outputs the caption relating to “Park Ji-sung goal,” the real-time issue determiner 211 may determine the reason of the real-time issue scene as “Park Ji-sung goal.”

Next, the preference determiner 209 may send the determined real-time issue scene and its reason information to the broadcasting output device.

The memory 213 can store commands or data received from or generated by the processor 205 and the communication interface 203. The memory 213 can include, although not depicted, programming modules such as kernel, middleware, application programming interface, or application. The programming modules can be implemented using software, firmware, hardware, or a combination of at least two of these. The memory 213 can store the user information received during a certain time among the social media data received during a certain time. The memory 213 can store the buzz information, the rating information, and the preference information per broadcasting program.

An apparatus of a server can include a communication interface, and a processor configured to receive social media data from social media server through the communication interface, obtain broadcasting information from the social media data, receive broadcasting viewing log information from the at least one electronic device through the communication interface, and control the communication interface to send preference information of at least one broadcasting program determined based on the broadcasting information and the broadcasting viewing log information, to the at least one electronic device.

The processor can extract broadcasting program information by monitoring the social media data, determine an amount of buzz per broadcasting program based on the extracted broadcasting program information, determines a broadcasting program rating based on the broadcasting viewing log information, and determine the preference of the at least one broadcasting program based on the determined broadcasting program buzz and the broadcasting program rating.

The processor may determine a first weight for the broadcasting program buzz and a second weight for the broadcasting program rating based on a social media usage of a broadcasting program viewer age, and determine the broadcasting program preference based on the buzz applied with the first weight and the rating applied with the second weight.

The processor may determine an issue scene based on at least one of a change of the determined broadcasting program buzz and a change of the broadcasting program rating, and control the communication interface to send the determined issue scene to the at least one electronic device.

The processor may collect at least one of audio information, video information, and text information per broadcasting program, determine an issue scene based on at least one of the collected information, a change of the determined broadcasting program buzz, and a change of the broadcasting program rating, and control the communication interface to send the determined issue scene to the at least one electronic device.

The processor may determine the issue scene based on at least one of an audio volume of a broadcasting program, a repeated replay of a particular scene of a broadcasting program, or a word and a sentence in broadcasting program captioning.

The processor may determine a reason of the real-time issue scene based on at least one of the text information per broadcasting program and the broadcasting program information extracted by monitoring the social media data.

The processor may obtain broadcasting program information and personal information of a social media user by monitoring the social media data, and determine at least one of a viewer age, a viewer gender, and user emotion information per broadcasting program based on the broadcasting program information and the user personal information.

An apparatus of a server can include a display, a communication interface, and a processor configured to receive issue scene information of a broadcasting program from at least one server, and control the display to output the received broadcasting program issue scene information.

The issue scene information comprises at least one of at least one image relating to the issue scene and an issue scene reason.

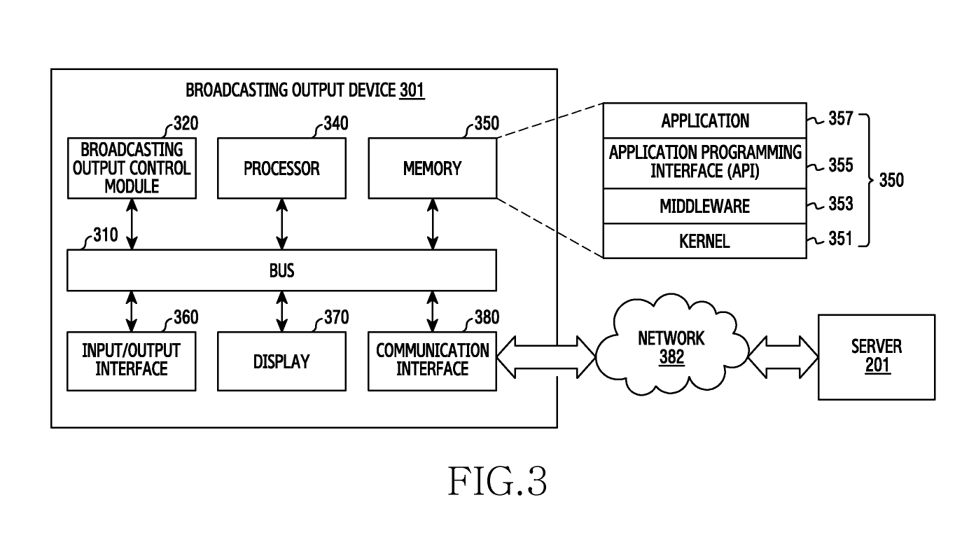

FIG. 3 depicts a network including a broadcasting output device according to an embodiment of the present disclosure.

Referring to FIG. 3, the broadcasting output device 301 may include a bus 310, a broadcasting output control module 320, a processor 340, a memory 350, an input/output interface 360, a display 370, and a communication interface 380.

The bus 310 may interlink the components 320 through 380 of the broadcasting output device 301 and control communications (e.g., control messages) between the components of the broadcasting output device 301.

The broadcasting output control module 320 may output a broadcasting program. The broadcasting output control module 320 may also transmit viewing log of the broadcasting program to the server 201, when the broadcasting output control module 320 output the broadcasting program. In particular, the broadcasting output control module 320 may display broadcasting program preference information received from the server 201 on a portion of an area of current broadcasting program, when input for outputting the preference information is received. When a particular broadcasting program is selected by user, the broadcasting output control module 320 may output viewer age distribution map, the user gender ratio, the viewer emotion information per the particular broadcasting program.

Additionally, the broadcasting output control module 320 may output a real-time issue scene and its reason. For example, when the real-time issue scene and its reason is received by server 201, the broadcasting output control module 320 may output real-time issue scene and its reason in popup window or notification window while outputting the broadcasting program. For example, the broadcasting output control module 320 may output real-time issue scene and its reason while the broadcasting program is not outputting. The broadcasting output control module 320 may thus attract a user to view a broadcasting program.

The processor 340 may receive an instruction from the other components (e.g., the broadcasting output control module 320, the memory 350, the input/output interface 360, the display 370, and the communication interface 380) of the broadcasting output device 301 via the bus 310, interpret the received instruction, and perform an operation or process data according to the interpreted instruction.

The memory 350 may store the instruction or the data received from or generated by the processor 340 or the other components (e.g., the broadcasting output control module 320, the memory 350, the input/output interface 360, the display 370, and the communication interface 380). For example, the memory 350 may include programming modules of a kernel 351, middleware 353, an application programming interface (API) 355, and an application 357. The programming module may be implemented using software, firmware, and hardware, or a combination of at least two of these.

The input/output interface 360 may forward an instruction or data input from the user through an input device (e.g., a sensor, a keyboard, or a touch screen) to, for example, one or more of the broadcasting output control module 320, the processor 340, the memory 350, and the communication interface 380 via the bus 310. For example, the input/output interface 360 may forward data of the user's touch input through the touch screen, to the processor 340.

The display 370 may display various information (e.g., multimedia data or text data) to the user. For example, the display 370 may display the command or the data fed from the broadcasting output control module 320, the processor 340, the memory 350, and the communication interface 380 via the bus 310.

The communication interface 380 may establish the communication between the broadcasting output 301 and the external device (e.g., the server 201). For example, the communication interface 380 may wirelessly communicate with the server 201 over a network 382. The wireless communication may include one or more of, for example, WiFi, BT, BLE, NFC, the satellite communication (e.g., GPS), and the cellular communication (e.g., LTE, LTE-A, CDMA, WCDMA, UMTS, WiBro, or GSM).

A protocol (e.g., transport layer protocol, data link layer protocol, or physical layer protocol) for the communication between the broadcasting output device 301 and the server 201 may be supported by one or more of the application, the API, the middleware, and the kernel of the memory 350 and the communication interface 380.

An electronic device can include a display, a communication interface for sending and receiving signals to and from at least one server, and a processor for receiving issue scene information of a broadcasting program from the server and controlling to output the received broadcasting program issue scene information through the display.

The issue scene information may include at least one of at least one image relating to the issue scene and an issue scene reason.

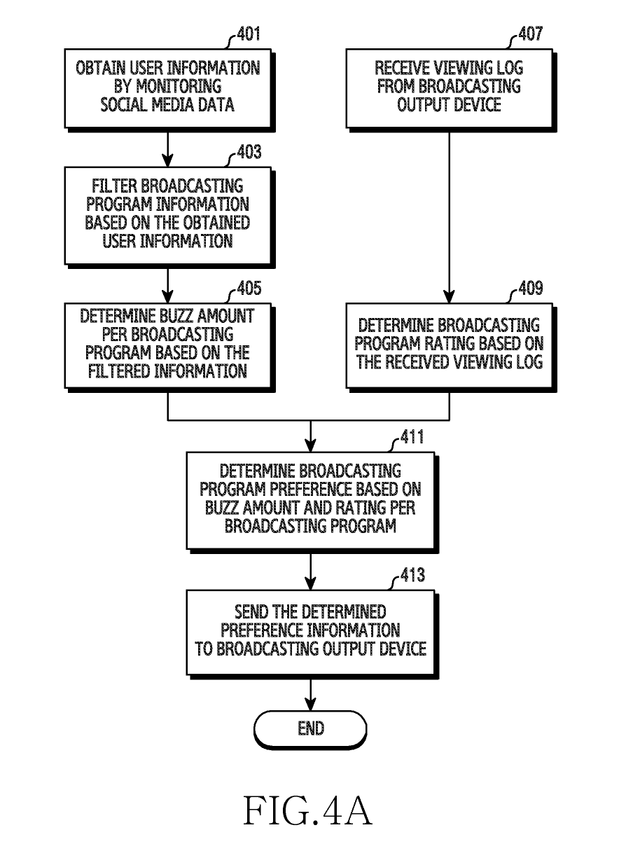

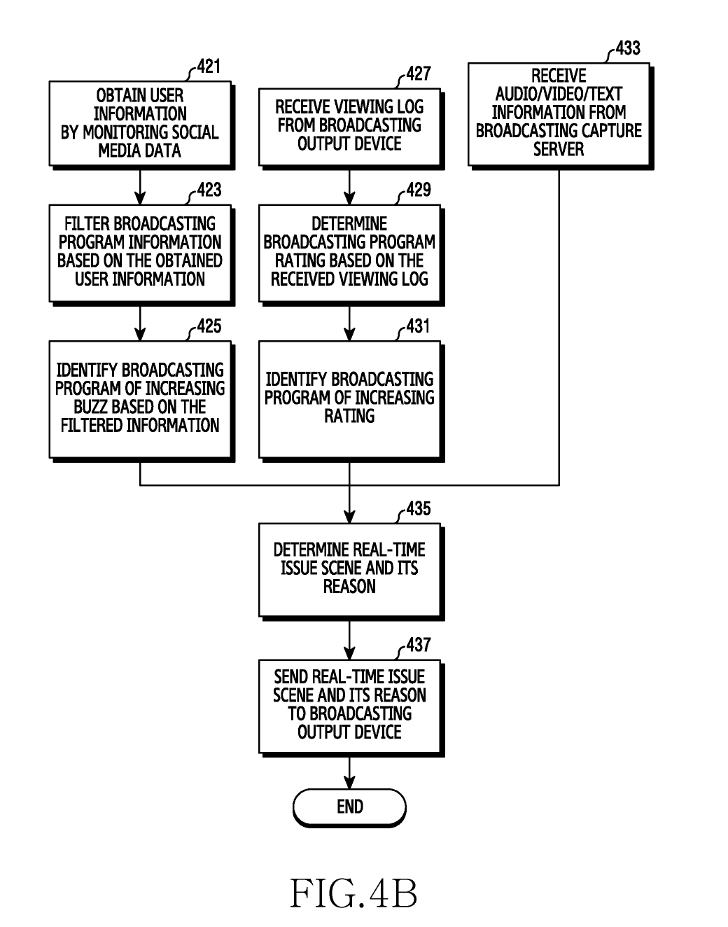

FIG. 4A illustrates a method for determining broadcasting program preference in a server according to an embodiment of the present disclosure.

Referring to FIG. 4A, the server obtains the user information by monitoring the social media data in operation 401. The user information may include the user personal information and the user posting information.

In operation 403, the server filters the broadcasting program information based on the obtained user information. For example, the server may obtain the user's gender, age, residence, job, and emotion information based on the user information acquired by monitoring the social media data and the filtered information of the broadcasting program information. For example, the server may determine the viewer age distribution map, the user gender ratio, and the viewer emotion information per broadcasting program based on the obtained information.

In operation 405, the server determines the amount of buzz per broadcasting program based on the filtered information. For example, the server may filter the broadcasting program information from the received user information, and determine the buzz amount per broadcasting program based on the filtered broadcasting program information. The server may determine buzz ranking per broadcasting program.

In operation 407, the server receives the viewing log from the broadcasting output device. The operations 401 and 407 are the separate operations independently performed in the server, and may be conducted at the same time or at different times. For example, the operation 401 may precede, follow, or coincide with the operation 407.

In operation 409, the server receiving the viewing log from the broadcasting output device determines the broadcasting program rating based on the viewing log.

In operation 411, the server determines the broadcasting program preference based on the buzz amount and the rating per broadcasting program. In so doing, the server may determine the broadcasting program preference by applying different buzz and rating weights according to the main viewer age group per broadcasting program. For example, when main viewers of the first broadcasting program are in an age group including many social media users, the server may determine the preference of the first broadcasting program by applying a higher buzz weight of the first broadcasting program than the rating weight of the first broadcasting program. For example, when main viewers of the second broadcasting program are an age group including fewer social media users, the server may determine the preference of the second broadcasting program by applying a higher rating weight of the second broadcasting program than the buzz weight of the second broadcasting program.

In operation 413, the server sends the broadcasting program preference information to the broadcasting output device. In so doing, the server may also send the viewer age distribution map per broadcasting program, the viewer gender ratio, and the viewer emotion information, to the broadcasting output device.

Next, the server finishes this process.

FIG. 4B illustrates a method for determining a real-time issue scene and a reason of the issue scene in a server according to an embodiment of the present disclosure.

Referring to FIG. 4B, the server may obtain the user information by monitoring the social media data in operation 421. The user information may include the user's personal information and the user posting information.

In operation 423, the server filters the broadcasting program information based on the user information. The server may acquire the user's gender, age, residence, job, and emotion information based on the user information acquired by monitoring the social media data and the filtered broadcasting program information. In addition, the server may determine the viewer age distribution map per broadcasting program, the viewer gender ratio, and the viewer emotion information based on the acquired user information.

In operation 425, the server identifies the broadcasting program of increasing buzz based on the filtered information. For example, the server may identify the broadcasting program having the instantaneous buzz increase exceeding a preset threshold.

The server receives the viewing log from the broadcasting output device in operation 427 and determines the broadcasting program rating based on the received viewing log in operation 429. The server identifies the broadcasting program of increasing rating based on the broadcasting program rating in operation 431. For example, the server may identify the broadcasting program having the instantaneous rating increase exceeding a preset threshold. Herein, the threshold may be fixed or dynamically calculated using past rating change.

In operation 433, the server receives the audio/video/text information from the broadcasting capture server. For example, the server may receive the audio information, the video information, and/or the text information of the broadcasting program from the broadcasting capture server.

The operations 421, 427, and 433 are the separate operations independently conducted in the server, and may be performed at the same time or at different times.

In operation 435, the server determines the real-time issue scene and its reason. For example, the server may identify the broadcasting program of increasing buzz based on the user information acquired by monitoring the social media data, identify the broadcasting program of increasing rating based on the viewing log received from the broadcasting output device, and determine the candidate issue scenes based on the audio/video/text information received from the broadcasting capture server. The server may determine the real-time issue scene and its reason based on the broadcasting program of the increasing buzz, the broadcasting program of the increasing rating, and the candidate issue scenes. The reason of the real-time issue scene explains why the corresponding scene is the issue. In particular, the reason of the real-time issue scene may be determined based on the filtered broadcasting program information obtained by monitoring the social media data and the text information of the broadcasting program.

In operation 437, the server sends the real-time issue scene and its reason to the broadcasting output device.

Next, the server finishes this process.

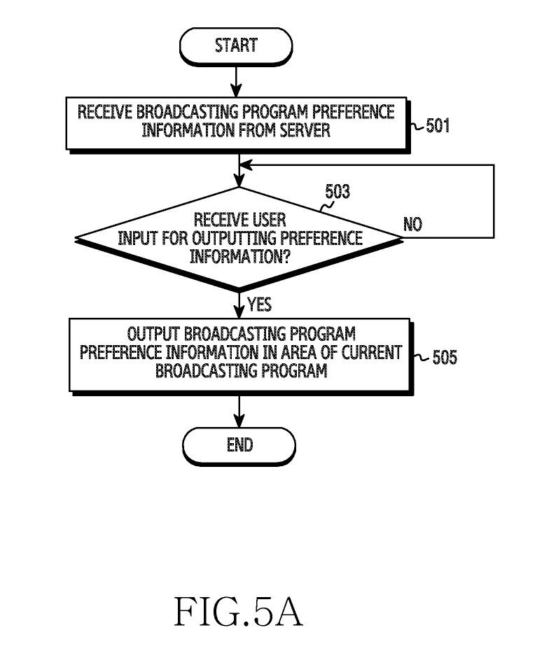

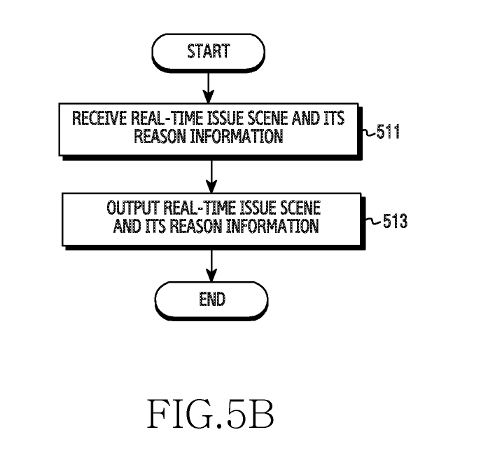

FIG. 5A illustrates a method for outputting broadcasting program preference in a broadcasting output device according to an embodiment of the present disclosure.

Referring to FIG. 5A, the broadcasting output device may receive the broadcasting program preference information from the server in operation 501. The broadcasting output device may receive the broadcasting program preference information from the server at preset time intervals, or send a broadcasting program preference information request message to the server according to a user input and then receive the broadcasting program preference information from the server in response.

In operation 503, the broadcasting output device determines whether a user input for outputting the preference information is received or not. When not receiving the user input for outputting the preference information, the broadcasting output device may stand by without outputting the preference information until the user input is received.

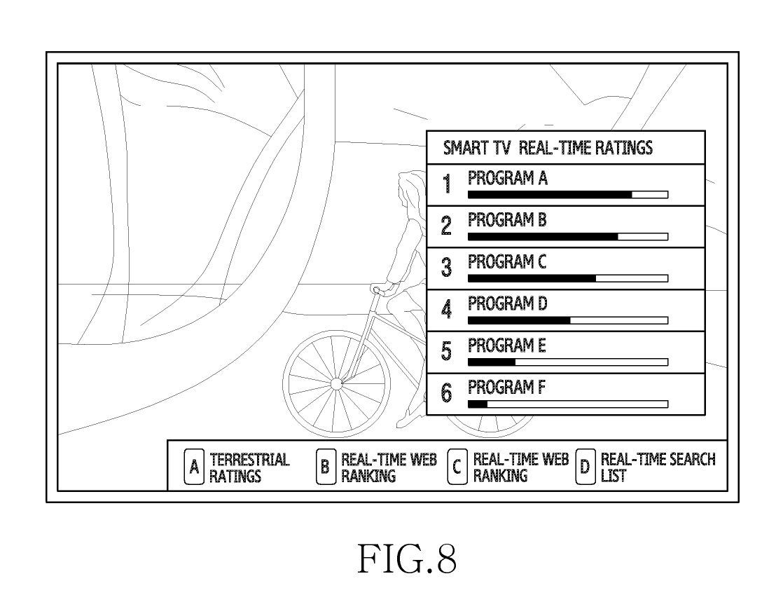

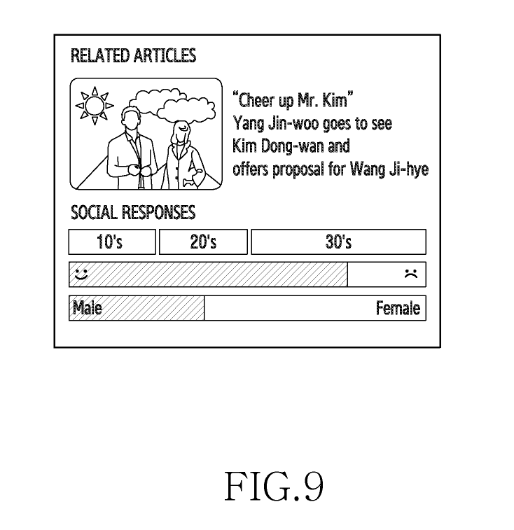

When receiving the user input for outputting the preference information, the broadcasting output device may output the broadcasting program preference information in an area of the current broadcasting program in operation 505. For example, the broadcasting output device may output the broadcasting program preference information based on the broadcasting program preference ranking. More specifically, as shown below in FIG. 8, the broadcasting output device may display a broadcasting program preference list on part of a screen while outputting the broadcasting program on the screen. The broadcasting program preference list may include the rating and broadcasting channel information of current broadcasting programs. When the user selects a particular program in the broadcasting program preference list as shown in FIG. 8, the broadcasting output device may further display detailed information (e.g., an image acquired by monitoring the social media data, a related article, a viewer ratio per age, emotion information, and a viewer gender ratio) of the corresponding program as shown in FIG. 9.

For example, when not outputting the broadcasting program, the broadcasting output device may output the preference information on all or part of the screen. The broadcasting output device may output the preference information using a separate popup window.

Next, the broadcasting output device may finish this process.

FIG. 5B illustrates a method for determining a real-time issue scene and a reason of the issue scene in a broadcasting output device according to an embodiment of the present disclosure.

Referring to FIG. 5B, the broadcasting output device may receive the real-time issue scene and its reason information in operation 511. The broadcasting output device may receive the real-time issue scene and its reason information from the server at preset time intervals, or send a real-time issue scene request message to the server according to the user input and then receive the real-time issue scene and its reason information from the server in response. For example, the broadcasting output device may receive the real-time issue scene and its reason information every time the server determines the real-time issue scene.

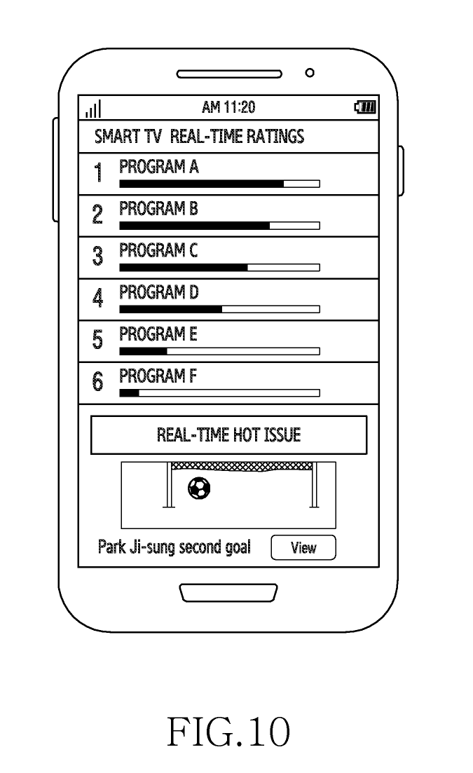

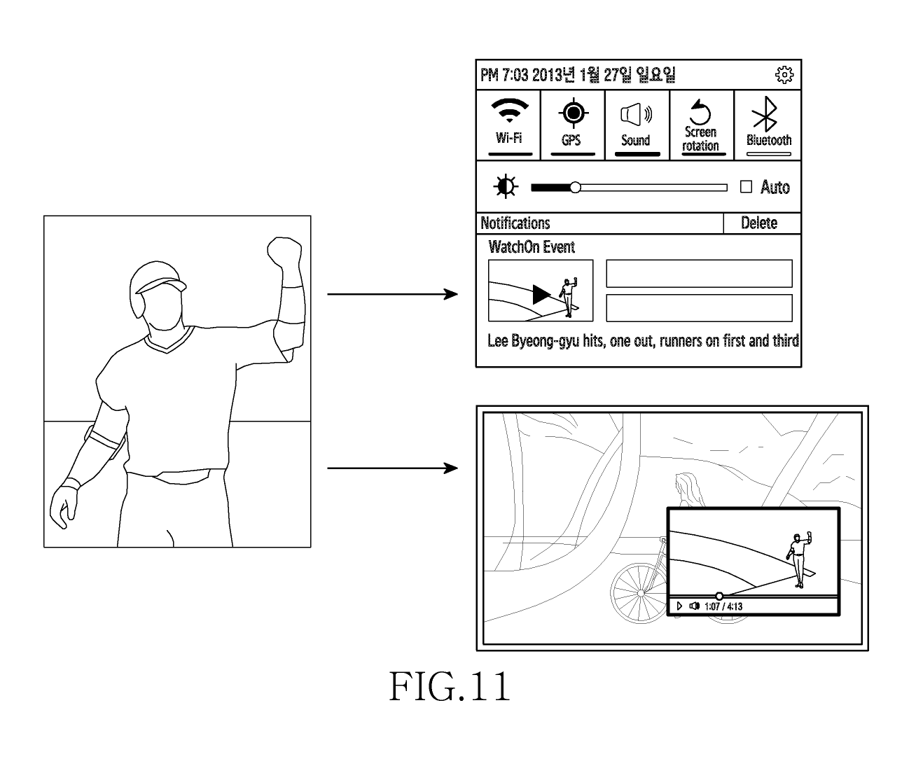

In operation 513, the broadcasting output device may output the real-time issue scene and its reason. The broadcasting output device may output the real-time issue scene and its reason using a popup message or a separate notification window. For example, as shown in FIG. 10, the broadcasting output device may display a list of the current program rating and the current program broadcasting channels together with the real-time issue scene and its reason. In addition, the broadcasting output device can provide an interface allowing the user to immediately view the broadcasting program of the real-time issue scene. The broadcasting output device may determine a method for outputting the real-time issue scene and its reason information according to its type. For example, as shown in FIG. 11, when the broadcasting output device is a portable terminal such as smart phone, the broadcasting output device can output an event notification window indicating that a hitting play of a baseball program is the real-time issue. When the broadcasting output device is a television, the broadcasting output device can display the real-time issue hitting scene of the baseball program in part of the screen while outputting a particular broadcasting program on the screen.

Next, the broadcasting output device finishes this process.

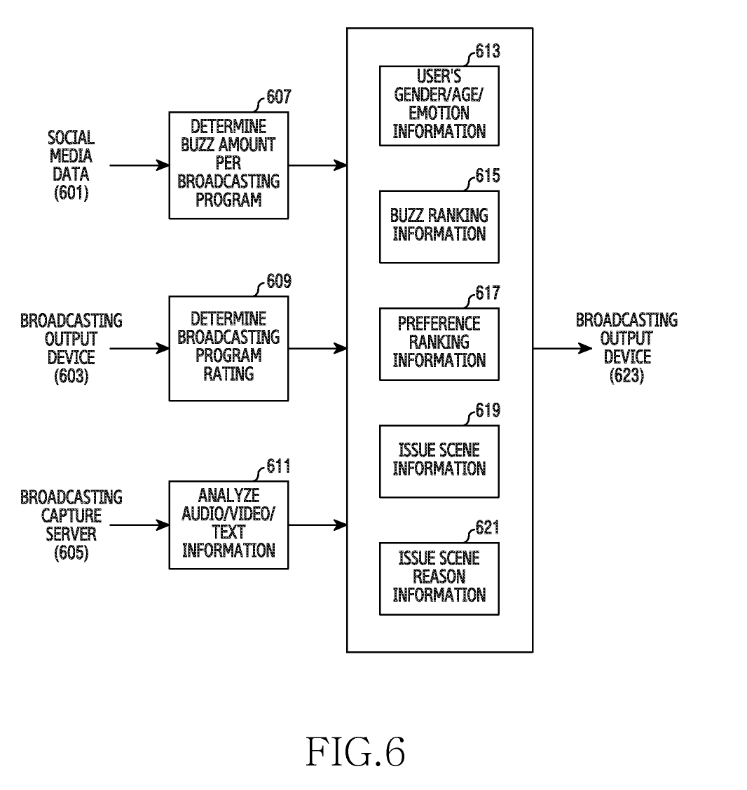

FIG. 6 depicts broadcasting program analysis in a server according to an embodiment of the present disclosure.

Referring to FIG. 6, the server may obtain user information by monitoring social media data 601, and determine the amount of buzz per broadcasting program by filtering broadcasting program information in the obtained user information in operation 607. For example, the server may extract the broadcasting program information from the received user information, and determine the broadcasting program buzz based on the extracted broadcasting program information.

The server may receive a broadcasting program viewing log from a broadcasting output device 603 and determine the real-time broadcasting program rating in operation 609. For example, the server may receive the real-time viewing log from the broadcasting output devices 603, analyze the received viewing logs, and determine the broadcasting program rating.

The server may receive audio/video/text information of the broadcasting program from a broadcasting capture server 605, and analyze the audio/video/text information in operation 611. For example, the server may receive the audio information, the video information, and/or the text information of the broadcasting program from the broadcasting capture server, and analyze the received information.

The server may determine the user's gender/age/emotion information 613, the buzz ranking information 615, the preference ranking information 617, the issue scene information 619, and the issue scene reason information 621 based on the information received from the social media data 601, the broadcasting output devices 603, and the broadcasting capture server 605. For example, the server may determine the user's gender/age/emotion information 613 based on the user information obtained by monitoring the social media data 601. The server may determine the buzz amount of the broadcasting program based on the filtered broadcasting program information obtained by monitoring the social media data 601, and determine the buzz ranking information 615 based on the determined buzz amount. The server may determine the buzz amount of the broadcasting program based on the user information obtained by monitoring the social media data 601, determine the broadcasting program rating based on the viewing log information received from the broadcasting output devices 603, and then determine the preference ranking information 617 of the broadcasting program based on the buzz mount and the rating of the broadcasting program. The server may determine the broadcasting program of the increasing buzz based on the user information obtained by monitoring the social media data 601, determine the broadcasting program of the increasing rating based on the viewing log information received from the broadcasting output devices 603, and determine the real-time issue scene information 619 based on the broadcasting program of the increasing buzz, the broadcasting program of the increasing rating, and the audio/video/text information received from the broadcasting capturing server 605. The server may determine the issue scene reason information 621 based on the filtered broadcasting program information obtained by monitoring the social media data 601 and the text information received from the broadcasting capturing server 605.

The server may send at least one of the user's gender/age/emotion information, the buzz ranking information, the preference ranking information, the issue scene information, and the issue scene reason information to the broadcasting output device in operation 623.

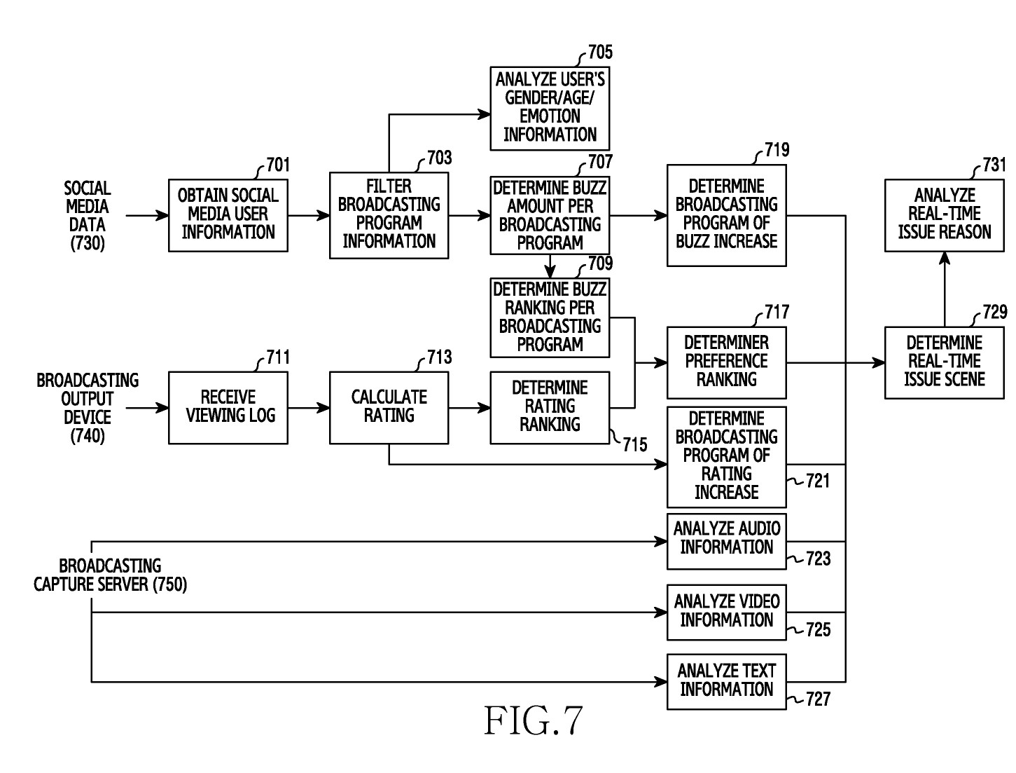

FIG. 7 depicts detailed broadcasting program analysis in a server according to an embodiment of the present disclosure.

Referring to FIG. 7, the server may obtain social media user information by monitoring social media data 730 in operation 701. The user information may include the user's personal information and the user posting information. For example, the server may receive the user posting information by monitoring the social media data 730. For example, the server may receive the user personal information by monitoring the social media data 730.

In operation 703, the server may filter broadcasting program information. That is, the server may filter the broadcasting program information based on the user information acquired by monitoring the social media data 730. For example, the server may filter the broadcasting program information in the user's posting.

In operation 705, the server may analyze the user's gender/age/emotion. For example, the server may analyze and determine the user's gender/age/emotion information based on the user personal information of the user information acquired by monitoring the social media data 730. For example, the server may estimate the broadcasting program viewed by the user by filtering the broadcasting program information in the user's posting of the user information acquired by monitoring the social media data 730, and estimate the user's gender and age based on characteristics and type of the user's broadcasting program. For example, by filtering the broadcasting program information from the user's posting in the user information obtained by monitoring the social media data 730, the server may determine whether the user feels positive or negative about the corresponding broadcasting program.

In operation 707, the server may determine the buzz amount per broadcasting program. For example, the server may filter the broadcasting program information from the user information acquired by monitoring the social media data 730, and determine the buzz amount per broadcasting program.

In operation 709, the server may determine the buzz ranking of the broadcasting program based on the broadcasting program buzz.

In operation 711, the server may obtain the social media user information from a broadcasting output device 740. That is, the server may receive viewing log information indicating which broadcasting program is output from the broadcasting output device 740, from at least one broadcasting output device. For example, the server may receive viewing log information indicating that a first broadcasting output device outputs a first broadcasting program and a second broadcasting output device outputs a second broadcasting program, from the first broadcasting output device and the second broadcasting output device.

In operation 713, the server may calculate the broadcasting program rating. That is, the server may calculate the broadcasting program rating based on the viewing log information received from the broadcasting output device 740.

In operation 715, the server may determine the broadcasting program rating ranking based on the broadcasting program rating.

In operation 717, the server may determine the broadcasting program preference ranking based on the buzz ranking determined in operation 709 and the rating ranking determined in operation 715. In so doing, while the server may determine the broadcasting program preference ranking based on the buzz ranking and the rating ranking per broadcasting program, the server may determine the broadcasting program preference based on the buzz ranking and the rating ranking per broadcasting program without determining the ranking and determine the preference ranking according to the determined preference. When determining the broadcasting preference, the server may apply different buzz weight and rating weight according to the viewer age group per broadcasting program. For example, when main viewers of the first broadcasting program are in an age group including many social media users, the server may determine the preference of the first broadcasting program by applying a higher buzz weight than the rating weight. For example, when main viewers of the second broadcasting program are in an age group including less social media users, the server may determine the preference of the second broadcasting program by applying a higher rating weight than the buzz weight.

After operation 707, the server may determine the broadcasting program of the buzz increase in operation 719. That is, the server may identify the broadcasting program having the instantaneous buzz increase exceeding a preset threshold.

After operation 713, the server may determine the broadcasting program of the rating increase in operation 721. That is, the server may identify the broadcasting program having the instantaneous rating increase exceeding a preset threshold.

In operation 729, the server may determine the real-time issue scene based on the broadcasting program of the abrupt buzz increase, the broadcasting program of the abrupt rating increase, and the analysis on the audio/video/text information received from the broadcasting capture server 750 in operations 723 Analyze Audio Information, 725 Analyze Video Information, and 727 Analyze Text Information. For example, the server may determine the real-time issue scene based on the audio, video, and text information analyses corresponding to the broadcasting program of the buzz increase and the broadcasting program of the rating increase. More specifically, the server may determine a scene when the audio volume of the broadcasting program of the abrupt buzz and the rating increase exceeds a preset threshold, as the real-time issue scene. For example, when a particular scene is replayed more than twice in the broadcasting program of the abrupt buzz and the rating increase, the server may determine the corresponding scene as the candidate issue scene.

In operation 731, the server may analyze the reason of the real-time issue scene. For example, the server may determine the real-time issue reason based on the filtered broadcasting program information obtained by monitoring the social media data and the broadcasting program text information. More specifically, the server filters the broadcasting program information obtained by monitoring the social media data at the time of the real-time issue scene determination or the broadcasting. When postings relating to “Park Ji-sung” are uploaded most and the text information of the broadcasting program outputs the caption relating to “Park Ji-sung goal,” the server may determine the reason of the real-time issue scene as “Park Ji-sung goal.”

An operating method of a server may include receiving social media data from social media server, obtaining broadcasting information from social media data, receiving broadcasting viewing log information from at least one electronic device, and sending preference information of at least one broadcasting program determined based on the broadcasting information and the broadcasting viewing log information, to the at least one electronic device.

The operating method may further include determining an amount of buzz per broadcasting program based on the broadcasting program information, determining a broadcasting program rating based on the broadcasting viewing log information; and determining the preference of the at least one broadcasting program based on the determined broadcasting program buzz and the broadcasting program rating.

The determining of the preference may include determining a first weight on the broadcasting program buzz and a second weight on the broadcasting program rating based on a social media usage of a broadcasting program viewer age, and determining the broadcasting program preference based on the buzz applied with the first weight and the rating applied with the second weight.

The operating method may further include determining an issue scene based on at least one of a change of the determined broadcasting program buzz and a change of the broadcasting program rating, and sending the determined issue scene to the at least one electronic device.

The determining of the issue scene may include collecting at least one of audio information, video information, and text information per broadcasting program, and determining an issue scene based on at least one of the collected information, a change of the determined broadcasting program buzz, and a change of the broadcasting program rating.

The issue scene may be determined based on at least one of an audio volume of a broadcasting program, a repeated replay of a particular scene of a broadcasting program, and a word or a sentence of broadcasting program captioning.

The reason of the real-time issue scene may be determined based on at least one of text information per broadcasting program and the broadcasting program information extracted by monitoring the social media data.

The operating method may further include obtaining personal information of a social media user by monitoring the social media data, and determining at least one of a viewer age, a viewer gender, and user emotion information per broadcasting program based on the broadcasting program information and the user personal information.

An operating method of an electronic device may include receiving issue scene information of a broadcasting program from a server, and displaying the received broadcasting program issue scene information.

The issue scene information may include at least one of at least one image relating to the issue scene and an issue scene reason.

FIG. 8 illustrates broadcasting program preference information output on a television according to an embodiment of the present disclosure.

FIG. 9 illustrates detailed broadcasting program preference information output on a television according to an embodiment of the present disclosure.

FIG. 10 illustrates broadcasting program preference information output on a smart phone according to an embodiment of the present disclosure.

FIG. 11 illustrates real-time issue information output from a broadcasting output device according to an embodiment of the present disclosure.

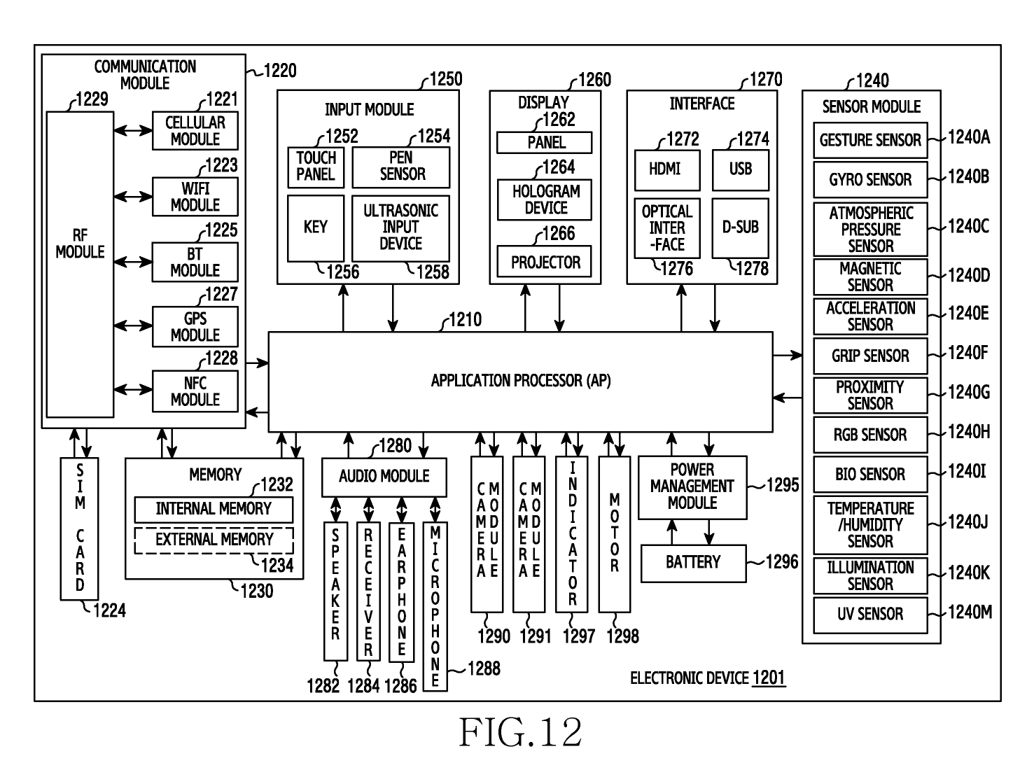

FIG. 12 is a block diagram of an electronic device for supporting a broadcasting output function according to an embodiment of the present disclosure.

The electronic device 1200 may include all or some of the components of the broadcasting output device 301 illustrated in FIG. 3. Referring to FIG. 12, the electronic device 1200 may include one or more application processors (AP) 1210, a communication module 1220, a subscriber identification module (SIM) card 1224, a memory 1230, a sensor module 1240, an input module 1250, a display 1260, an interface 1270, an audio module 1280, a camera module 1291, a power management module 1295, a battery 1296, an indicator 1297, and a motor 1298.

The AP 1210 drives an operating system (OS) or an application to control a plurality of hardware or software elements connected to the AP 1210 and performs various data processes including multimedia data and operations. The AP 1210 may be implemented, for example, as a system on chip (SoC). The AP 1210 may further include a graphic processing unit (GPU).

The communication module 1220 (e.g., the communication interface 380) may transmit and receive data in the communication between the electronic device 1200 (e.g., the broadcasting output device 301) and other electronic devices (e.g., the server 201) connected over the network. The communication module 1220 may include a cellular module 1221, a WiFi module 1223, a BT module 1225, a GPS module 1227, an NFC module 1228, and a radio frequency (RF) module 1229.

The cellular module 1221 provides voice communication, image communication, a short message service, or an Internet service, etc. via a communication network (e.g., LTE, LTE-A, CDMA, WCDMA, UMTS, WiBro, or GSM, etc.). Also, the cellular module 1221 may perform discrimination and authentication of an electronic device within a communication network using, for example, a Subscriber Identify Module (e.g., a SIM card 1224). The cellular module 1221 may perform at least a portion of functions that may be provided by the AP 1210. For example, the cellular module 1221 may perform at least part of a multimedia control function.

The cellular module 1221 may include a communication processor (CP). The cellular module 1221 may be implemented using, for example, a SoC. While the components of the cellular module 1221 (e.g., the CP), the memory 1230, and the power management module 1295 are separated from the AP 1210 in FIG. 12, the AP 1210 may include at least part (e.g., the cellular module 1221) of the above-stated components.

The AP 1210 or the cellular module 1221 (e.g., the CP) may load and process the instruction or the data received from its connected non-volatile memory or one or more of the other components, in a volatile memory. Also, the AP 1210 or the cellular module 1221 may store data received from or generated by one or more of the other components, in the non-volatile memory.

Each of the WiFi module 1223, the BT module 1225, the GPS module 1227, or the NFC module 1228 may include, for example, a processor for processing data transmitted/received via a relevant module. While the cellular module 1221, the WiFi module 1223, the BT module 1225, the GPS module 1227, and the NFC module 1228 are separated from each other in FIG. 12, at least part (e.g., at least two) of the cellular module 1221, the WiFi module 1223, the BT module 1225, the GPS module 1227, and the NFC module 1228 may be included in a single integrated chip (IC) or an IC package. For example, at least part (e.g., the CP corresponding to the cellular module 1221 and the WiFi processor corresponding to the WiFi module 1223) of the processors corresponding to the cellular module 1221, the WiFi module 1223, the BT module 1225, the GPS module 1227, and the NFC module 1228 may be implemented using a single SoC.

The RF module 1229 may transmit and receive the data, for example, RF signals. The RF module 1229 may include, for example, a transceiver, a power amp module (PAM), a frequency filter, and a low noise amplifier (LNA), which are not shown. Also, the RF module 1229 may further include a component, for example, a conductor or a conducting wire, for sending and receiving electromagnetic waves in free space during the wireless communication. While the cellular module 1221, the WiFi module 1223, the BT module 1225, the GPS module 1227, and the NFC module 1228 share the single RF module 1229 in FIG. 12, one or more of the cellular module 1221, the WiFi module 1223, the BT module 1225, the GPS module 1227, and the NFC module 1228 may transmit and receive the RF signals via a separate RF module.

The SIM card 1224 may be inserted into a slot formed in a specific position of the electronic device 1200. The SIM card 1224 may include unique identify information (e.g., integrated circuit card identifier (ICCID)) or subscriber information (e.g., international mobile subscriber identity (IMSI)).

The memory 1230 (e.g., the memory 330) includes an internal memory 1232 or an external memory 1234. The internal memory 1232 may include, for example, one or more of a volatile memory (e.g., dynamic RAM (DRAM), static RAM (SRAM), synchronous dynamic RAM (SDRAM)) and a non-volatile memory (e.g., one time programmable ROM (OTPROM), programmable ROM (PROM), erasable and programmable ROM (EPROM), electrically erasable and programmable ROM (EEPROM), mask ROM, flash ROM, not and (NAND) flash memory, not or (NOR) flash memory, etc.).

The internal memory 1232 may be a solid state drive (SSD). The external memory 1234 may further include a flash drive, for example, compact flash (CF), secure digital (SD), micro SD (Micro-SD), mini SD (Mini-SD), extreme Digital (xD), or a memory stick. The external memory 1234 may be functionally connected with the electronic device 1201 via various interfaces. The electronic device 1201 may further include a storage device (or a storage medium) such as a hard drive.

The sensor module 1240 measures a physical quantity or detects an operation state of the electronic device 1201 and converts the measured or detected information to an electric signal. The sensor module 1240 includes, for example, one or more of a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (e.g., red, green, blue (RGB) sensor), a living body (bio) sensor 1240I, a temperature/humidity sensor 1240J, an illumination sensor 1240K, or an ultra violet (UV) sensor 1240M. Additionally or alternatively, the sensor module 1240 may include, for example, an E-nose sensor, an electromyography (EMG) sensor, an electroencephalogram (EEG) sensor, an electrocardiogram (ECG) sensor, an infrared (IR) sensor, an iris sensor, or a fingerprint sensor, etc. The sensor module 1240 may further include a control circuit for controlling one or more sensor belonging thereto.

The input module 1250 may include a touch panel 1252, a (digital) pen sensor 1254, a key 1256, or an ultrasonic input device 1258. The touch panel 1252 recognizes a touch input using one or more of capacitive, resistive, infrared, or ultrasonic methods. Also, the touch panel 1252 may further include a control circuit. A capacitive touch panel may perform detection by a physical contact or proximity recognition. The touch panel 1252 may further include a tactile layer. In this case, the touch panel 1252 may provide a tactile reaction to a user.

The (digital) pen sensor 1254 may be implemented using, for example, the same or similar method as or to the user's touch input, or using a separate recognition sheet. For example, the key 1256 may include, for example, a physical button, an optical key, or a keypad. The ultrasonic input device 1258 is a device capable of obtaining data by detecting microwaves through a microphone (e.g., a microphone 1288) in the electronic device 1200 through an input tool which generates an ultrasonic signal, allows radio frequency identification. The electronic device 1200 may receive user input from an external device (e.g., a server or an internet of things (IoT) device) connected using the communication module 1220.

The display 1260 (e.g., the display 370) includes a panel 1262, a hologram device 1264, or a projector 1266. The panel 1262 may be, for example, a liquid crystal display (LCD), or an active-matrix organic light-emitting diode (AM-OLED), etc. The panel 1262 may be implemented, for example, such that it is flexible, transparent, or wearable. The panel 1262 may be configured as one module together with the touch panel 1252. The hologram device 1264 may project a three-dimensional image in the air using interferences of light. The projector 1266 may project light onto a screen to display an image. The screen may be positioned, for example, inside or outside the electronic device 1200. The display 1260 may further include a control circuit for controlling the panel 1262, the hologram device 1264, or the projector 1266.

The interface 1270 includes, for example, a high-definition multimedia interface (HDMI) 1272, a universal serial bus (USB) 1274, an optical interface 1276, or a d-subminiature (D-sub) 1278. The interface 1270 may be included, for example, in the communication interface 380 illustrated in FIG. 3. Additionally or alternatively, the interface 1270 may include, for example, a mobile high-definition link (MHL) interface, a SD card/multi-media card (MMC) interface, or an infrared data association (IrDA) standard interface.

The audio module 1280 may convert a sound and an electric signal in dual directions. At least a partial element of the audio module 1280 may be included, for example, in the I/O interface 360 illustrated in FIG. 3. The audio module 1280 processes sound information input or output via, for example, a speaker 1282, a receiver 1284, an earphone 1286, or the microphone 1288, etc.

The camera module 1291 is a device that may capture a still image and a moving picture. T camera module 1291 may include one or more image sensors (e.g., a front sensor or a rear sensor), a lens, an image signal processor (ISP), or a flash (e.g., an LED or xenon lamp).

The power management module 1295 may manage power of the electronic device 1201. The power management module 1295 may include, although not depicted, for example, a power management integrated circuit (PMIC), a charger integrated circuit (IC), or a battery or fuel gauge.

The PMIC may be mounted in, for example, an IC or a SoC conductor. The charging type may be divided to a wired type and a wireless type. The charger IC may charge the battery, and prevent overvoltage or overcurrent flow from the charger. The charger IC may include a charger IC for one or more of the wired charging type or the wireless charging type. The wireless charging type includes, for example, a magnetic resonance type, a magnetic induction type, and a microwave type, and may add an additional circuit for the wireless charging, for example, a circuit such as coil loop, resonance circuit, or rectifier.

The battery gauge may, for example, measure the remaining capacity of the battery 1296 and the voltage, the current, or the temperature of the charging. The battery 1296 may store or generate electricity, and supply the power to the electronic device 1200 using the stored or generated electricity. The battery 1296 may include, for example, a rechargeable battery or a solar battery.

The indicator 1297 displays a specific state of the electronic device 1200 or a portion thereof (e.g., the AP 1210), for example, a booting state, a message state, or a charging state, etc. The motor 1298 converts an electric signal to mechanical vibration. The electronic device 1200 includes a processor (e.g., a GPU) for supporting a mobile TV. The processor for supporting the mobile TV may process media data corresponding to standards, for example, such as DMB, DVB, or a media flow, etc.

Each of the aforementioned constitutional elements of the electronic device according to various embodiments of the present disclosure may consist of one or more components, and names thereof may vary depending on a type of electronic device. The electronic device according to various embodiments of the present disclosure may include one or more of the aforementioned constitutional elements. Some of the constitutional elements may be omitted, or additional other constitutional elements may be further included. In addition, some of the constitutional elements of the electronic device according to various embodiments of the present disclosure may be combined and constructed as one entity, so as to equally perform functions of corresponding constitutional elements before combination.

A terminology “module” used for the present disclosure may mean, for example, a unit including a combination of one or two or more among a hardware, a software, or a firmware. A “module” may be interchangeably used with a terminology such as a unit, a logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include one or more of an application-specific integrated circuit (ASIC) chip, a field-programmable gate arrays (FPGAs), or a programmable-logic device which are known, or to be developed in the future, and performing certain operations.

At least part of the device (e.g., the modules or the functions) or the method (e.g., the operations) described in the appended claims and/or the specifications of the present disclosure may be implemented using, for example, instructions stored as the programming module in a non-transitory computer-readable storage medium. For example, when an instruction is executed by one or more processors (e.g., the processor 340), the one or more processors perform the corresponding function. The non-transitory computer-readable storage medium may be, for example, the memory 350. At least part of the programming module may be implemented (e.g., executed) by the processor 340. At least part of the programming module may include, for example, a module, a program, sets of instructions, or a process for performing one or more functions.

The non-transitory computer-readable storage media may include a hard disk, a magnetic media such as a floppy disk and a magnetic tape, compact disc read only memory (CD-ROM), optical media such as DVD, magneto-optical media such as a floptical disk, and a hardware device specially configured for storing and performing a program instruction (e.g., a programming module) such as ROM, RAM, a flash memory, etc. Also, the program instruction may include not only a machine language code generated by a compiler but also a high-level language code executable by a computer using an interpreter, etc. The above-described hardware device may be configured to operate as one or more software modules in order to perform an operation of the present disclosure, and vice versa.

A module or programming module according to various embodiments may include one or more or more of the aforementioned constituent elements, or omit some of the aforementioned constituent elements, or include additional other constituent elements. Operations carried out by the module, the programming module or the other constituent elements according to various embodiments may be executed in a sequential, parallel, iterative or heuristic method. Also, some operations may be executed in different order or may be omitted, or other operations may be added.

In a storage medium storing instructions, the instructions, when executed by at least one processor, makes the at least one processor execute at least one operation. The at least one operation includes, in an electronic device, sending or receiving a first signal corresponding to a first communication network or a second signal corresponding to a second communication network, when receiving at least one signal, distributing the at least one signal to a first communication control module for processing the first signal and a second communication control module for processing a second signal based on whether a service provided by the electronic device corresponds to the first signal or the second signal.

As set forth above, the server can logically determine the broadcasting program preference based on the broadcasting program rating information and the social media buzz amount. Since the broadcasting program preference and the broadcasting program real-time issue scene information are provided to the broadcasting output device, the user can easily discover and view a popular broadcasting output device and/or a main broadcasting issue.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus of a server, the apparatus comprising:
a communication interface; and
a processor configured to:
receive a social media data from social media server through the communication interface,
obtain broadcasting information from the social media data,
receive broadcasting viewing log information from at least one electronic device through the communication interface, and
control the communication interface to send preference information of at least one broadcasting program determined based on the broadcasting information and the broadcasting viewing log information, to the at least one electronic device.

2. The apparatus of claim 1, wherein the processor is configured to:
extract broadcasting program information by monitoring the social media data,
determine an amount of buzz per broadcasting program based on the extracted broadcasting program information,
determine a broadcasting program rating based on the broadcasting viewing log information, and
determine the preference of the at least one broadcasting program based on the determined broadcasting program buzz and the broadcasting program rating.

3. The apparatus of claim 2, wherein the processor is configured to:
determine a first weight for the broadcasting program buzz and a second weight for the broadcasting program rating based on a social media usage of a broadcasting program viewer, and
determine the broadcasting program preference based on the buzz applied with the first weight and the rating applied with the second weight.

4. The apparatus of claim 2, wherein the processor is configured to:
determine an issue scene based on at least one of a change of the determined broadcasting program buzz and a change of the broadcasting program rating, and
control the communication interface to send the determined issue scene to the at least one electronic device.

5. The apparatus of claim 4, wherein the processor is configured to:
collect at least one of audio information, video information, and text information of broadcasting program,
determine an issue scene based on at least one of the collected information, a change of the determined broadcasting program buzz, and a change of the broadcasting program rating, and
control the communication interface to send the determined issue scene to the at least one electronic device.

6. The apparatus of claim 5, wherein the processor is configured to determine the issue scene based on at least one of an audio volume of a broadcasting program, a repeated replay of a particular scene of a broadcasting program, and a word or a sentence of broadcasting program captioning.

7. The apparatus of claim 5, wherein the processor is configured to determine a reason of the real-time issue scene based on at least one of the text information of broadcasting program and the broadcasting program information extracted by monitoring the social media data.

8. The apparatus of claim 1, wherein the processor is configured to:
obtain broadcasting program information and personal information of a social media user by monitoring the social media data, and
determine at least one of a viewer age, a viewer gender, and user emotion information per broadcasting program based on the broadcasting program information and the user personal information.

9. An electronic device comprising:
a display;
a communication interface; and
a processor configured to:
receive issue scene information of a broadcasting program from at least one server, and
control the display to output the received broadcasting program issue scene information.

10. The electronic device of claim 9, wherein the issue scene information comprises at least one of at least one image relating to the issue scene and an issue scene reason.

11. An operating method of a server, the method comprising:
receiving social media data from social media server;
obtaining broadcasting information from social media data;
receiving broadcasting viewing log information from at least one electronic device; and
sending preference information of at least one broadcasting program determined based on the broadcasting information and the broadcasting viewing log information, to the at least one electronic device.

12. The method of claim 11, further comprising:
determining an amount of buzz per broadcasting program based on the broadcasting program information;
determining a broadcasting program rating based on the broadcasting viewing log information; and
determining the preference of the at least one broadcasting program based on the determined broadcasting program buzz and the broadcasting program rating.

13. The method of claim 12, wherein the determining of the preference comprises:
determining a first weight on the broadcasting program buzz and a second weight on the broadcasting program rating based on a social media usage of a broadcasting program viewer; and
determining the broadcasting program preference based on the buzz applied with the first weight and the rating applied with the second weight.

14. The method of claim 12, further comprising:
determining an issue scene based on at least one of a change of the determined broadcasting program buzz and a change of the broadcasting program rating; and
sending the determined issue scene to the at least one electronic device.

15. The method of claim 14, wherein the determining of the issue scene comprises:
collecting at least one of audio information, video information, and text information per broadcasting program; and
determining an issue scene based on at least one of the collected information, a change of the determined broadcasting program buzz, and a change of the broadcasting program rating.

16. The method of claim 15, wherein the issue scene is determined based on at least one of an audio volume of a broadcasting program, a repeated replay of a particular scene of a broadcasting program, and a word or a sentence of broadcasting program captioning.

17. The method of claim 15, wherein the reason of the real-time issue scene is determined based on at least one of text information per broadcasting program and the broadcasting program information extracted by monitoring the social media data.

18. The method of claim 11, further comprising:
obtaining personal information of a social media user by monitoring the social media data; and
determining at least one of a viewer age, a viewer gender, and user emotion information per broadcasting program based on the broadcasting program information and the user personal information.

19. An operating method of an electronic device, the method comprising:
receiving issue scene information of a broadcasting program from a server; and
displaying the received broadcasting program issue scene information.

20. The method of claim 19, wherein the issue scene information comprises at least one of at least one image relating to the issue scene and an issue scene reason.
